(19) United States
(12) Patent Application Publication
(10) Pub. No.: US 2009/0031227 A1
(43) Pub. Date: Jan. 29, 2009

(54) INTELLIGENT SCREEN CAPTURE AND INTERACTIVE DISPLAY TOOL

(75) Inventors: Anindya Chakrabarti, Bangalore (IN); Satyam Kandula, Bangalore (IN)

Correspondence Address: CANTOR COLBURN LLP - IBM BOCA RATON, 20 Church Street, 22nd Floor, Hartford, CT, 06103, US

(73) Assignee: INTERNATIONAL BUSINESS MACHINES CORPORATION, Armonk, NY (US)

(21) Appl. No.: 11/829,387

(22) Filed: Jul. 27, 2007

(51) Int. Cl. G06F 3/048

(52) U.S. Cl. 715/763

(57) ABSTRACT

A computer program product stored on machine readable media and including machine executable instructions for capturing data displayed upon a screen and providing interactive screenshots created therefrom, the product including instructions for: receiving a selection of display data for capturing; capturing the display data by identifying a user interface component in the display data and at least one property of each user interface component; saving the captured display data as a data object model; storing the data object model as an intelligent image file; and using a rendering tool, reading the intelligent image file to provide the interactive screenshots.

### TRADEMARKS

IBM® is a registered trademark of International Business Machines Corporation, Armonk, N.Y., U.S.A. Other names used herein may be registered trademarks, trademarks or product names of International Business Machines Corporation or other companies.

### BACKGROUND OF THE INVENTION

1. Field of the Invention

This invention relates to capture of display data, and particularly to efficient data storage techniques.

2. Description of the Related Art

Currently the way images are captured from screens are by copying the image and saving it as a picture file (like JPEG,BMP etc). However such files are big compared to the information they carry. Bandwidth, B, required for such files can be described according to Eq. (1):

B=I/S (1);

where B represents bandwidth, I represents an amount of information and S represents a size of the information.

It is well known that many organizations typically store an abundance of such snapshots. Storage of such information poses a great expense in storage space. Another major problem is that these images are not interactive. Consider organizations such as a typical Information Technologies (IT) Support group. The IT support group may gather screenshots from users, consumers or customers and file them for analysis. Unfortunately, screenshots as are presently available often do not provide adequate information for troubleshooting.

What are needed are efficient techniques for storing display data. More specifically, what are needed are techniques for increasing bandwidth, B, as well as increasing information, I, while reducing size, S. Such techniques will inevitably result in savings from efficiencies in data storage and data transmission. Preferably, the techniques provide for including further aspects related to the display data. For example, the techniques should include at least some of the related functionality associated with the display data.

### SUMMARY OF THE INVENTION

The shortcomings of the prior art are overcome and additional advantages are provided through the provision of a computer program product stored on machine readable media that includes machine executable instructions for capturing data displayed upon a screen and providing interactive screenshots created therefrom, the product including instructions for: receiving a selection of display data for capturing; capturing the display data by identifying a user interface component in the display data and at least one property of each user interface component; saving the captured display data as a data object model; storing the data object model as an intelligent image file; and using a rendering tool, reading the intelligent image file to provide the interactive screenshots.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### TECHNICAL EFFECTS

As a result of the summarized invention, technically we have achieved a solution which efficient techniques for storing display data are provided. More specifically, techniques for increasing bandwidth, B, as well as increasing information, I, while reducing size, S, are disclosed. Such techniques result in savings by efficiencies in data storage and data transmission.

As an example, provided is a computer program product stored on machine readable media and including machine executable instructions supplementing at least one of an application and an operating system with instructions for capturing data displayed upon a screen and providing interactive screenshots created therefrom, the product including instructions for: receiving a selection of display data for capturing; capturing the display data by using an automated functional and regression testing tool to identify at least one user interface component including at least one of a location, a heading, a color, data, a flag, a type and a region in the display data, and at least one property of each user interface component; saving the captured display data as a data object model; storing the data object model as an intelligent image file; and using a rendering tool, reading the intelligent image file to provide the interactive screenshots.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 illustrates one example of a computing infrastructure for implementation of the teachings herein;

FIG. 2 illustrates exemplary aspects of software according to the teachings herein;

FIG. 3 depicts aspects of an exemplary data object model.

The detailed description explains the preferred embodiments of the invention, together with advantages and features, by way of example with reference to the drawings.

### DETAILED DESCRIPTION OF THE INVENTION

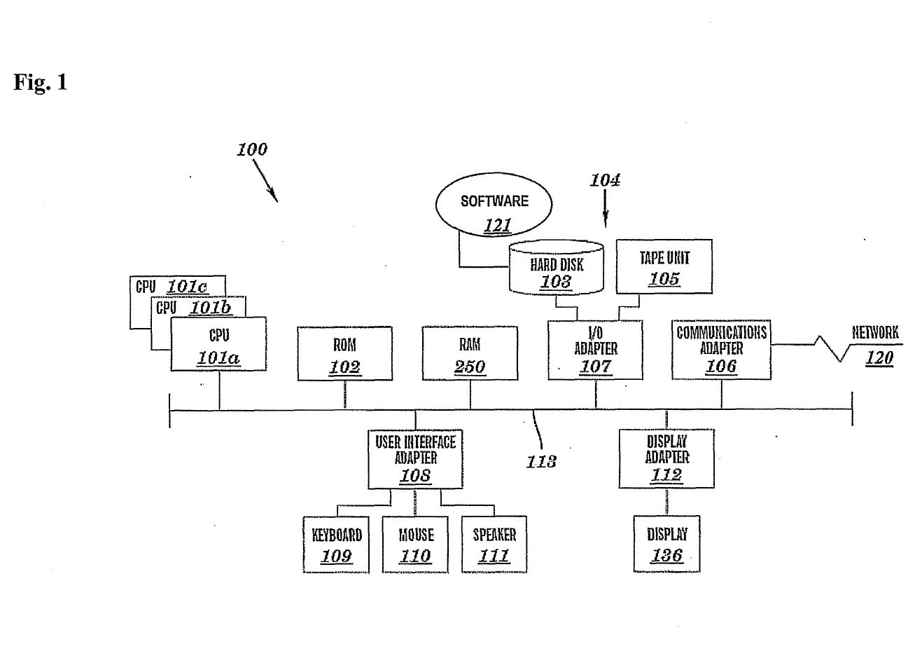

Referring to FIG. 1, there is shown an embodiment of a processing system 100 for implementing the teachings herein is depicted. System 100 has one or more central processing units (processors) 101a, 101b, 101c, etc. (collectively or generically referred to as processor(s) 101). In one embodiment, each processor 101 may include a reduced instruction set computer (RISC) microprocessor. Processors 101 are coupled to system memory 250 and various other components via a system bus 113. Read only memory (ROM) 102 is coupled to the system bus 113 and may include a basic input/output system (BIOS), which controls certain basic functions of system 100.

FIG. 1 further depicts an input/output (I/O) adapter 107 and a network adapter 106 coupled to the system bus 113. I/O adapter 107 may be a small computer system interface (SCSI) adapter that communicates with a hard disk 103 and/or tape storage drive 105 or any other similar component. I/O adapter 107, hard disk 103, and tape storage device 105 are collectively referred to herein as mass storage 104. A network adapter 106 interconnects bus 113 with an outside network 120 enabling data processing system 100 to communicate with other such systems. A screen (e.g., a display monitor) 136 is connected to system bus 113 by display adaptor 112, which may include a graphics adapter to improve the performance of graphics intensive applications and a video controller. In one embodiment, adapters 107, 106, and 112 may be connected to one or more I/O busses that are connected to system bus 113 via an intermediate bus bridge (not shown). Suitable I/O buses for connecting peripheral devices such as hard disk controllers, network adapters, and graphics adapters typically include common protocols, such as the Peripheral Components Interface (PCI). Additional input/output devices are shown as connected to system bus 113 via user interface adapter 108 and display adapter 112. A keyboard 109, mouse 110, and speaker 111 all interconnected to bus 113 via user interface adapter 108, which may include, for example, a Super I/O chip integrating multiple device adapters into a single integrated circuit.

As disclosed herein, the system 100 includes machine readable instructions stored on machine readable media (for example, the hard disk 104) for capture and interactive display of information shown on the screen 136 of a user. As referred to herein, the instructions are referred to as software 121. The software 121 may be produced using software development tools as are known in the art. As discussed herein, the software 121 may also referred to as a “screen capture tool” 121, an “interactive display tool” 121 or by other similar terms. The software 121 may include various tools and features for providing user interaction capabilities as are known in the art.

In some embodiments, the software 121 provides a capture and display tool as an overlay to another program providing for layout editing. For example, the software 121 may be provided as an “add-in” to an application (or operating system). Note that the term “add-in” is taken to mean supplemental program code as is known in the art. In such embodiments, the software 121 may replace structures of the application or operating system for storing display data.

As discussed herein, “capture” and related terms generally make reference to identifying data and recording data on a display 136. Often the data is stored in at least one of memory (such as RAM 250) and on the hard disk 103. Capturing data on the display 136 (i.e., “display data”) is generally equivalent to producing a “screenshot.” Each screenshot includes some to all of the information on the display 136 at the time of the capture. “Interaction” and related terms generally make reference to a user providing input to the processing system 100 as a result of some request for input, and the processing system 100 performing some function as a result of the input.

The software 121 provides users with an ability to capture data displayed on the screen 136 (perform “screenshots”). The software 121 also provides for display of screenshots and generally includes some functionality with the display. That is, in some embodiments, a user may interact with the screenshot. Advantageously, the screenshots provide for interaction with the user to an extent that is more rich in information than previously available while also using less storage space for the associated data.

Generally, display data is captured and stored as a “data object model.” The data object model may include object information and associated data contained by the object information.

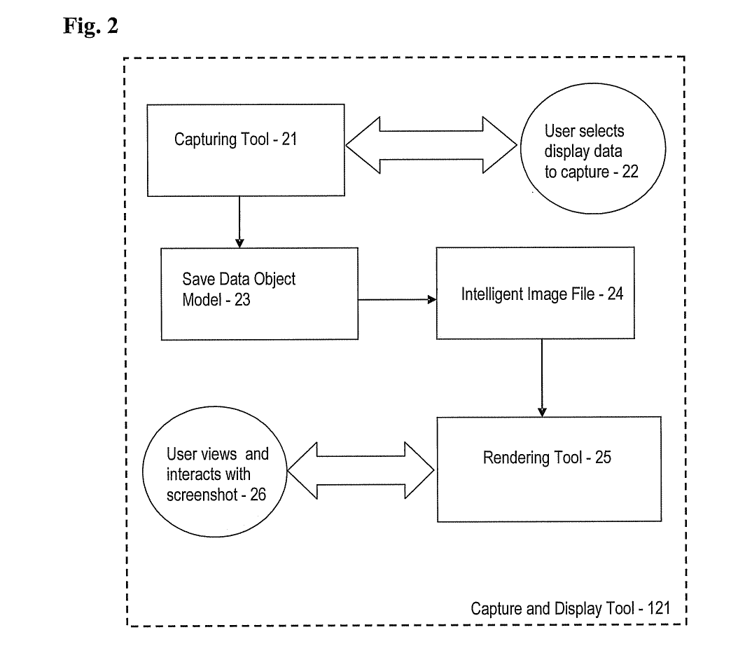

Referring now to FIG. 2, aspects of the software 121 (i.e., the capture and display tool 121) are shown. In general, it may be considered that the software provides a capturing tool 21 and a rendering tool 25. Once the user performs a step of selecting display data to capture 22, the software 121 generates the data object model 23 and an intelligent image file 24. The rendering tool 25 males use of the data object model 23 and the intelligent image file 24 to subsequently provide the user with a selected screenshot and interaction with the screenshot.

Consider the following description of this process, and the use of these tools and objects. In an exemplary embodiment, the software 121 enables the user to take a snapshot of display data for an application in use. The user can also chose a portion of the display for capture if only the portion is desired. As an example, the portion might be highlighted using a colored box. The portion may be equivalent to a “frame” as is known in user interface (UI) terminology.

After the user has completed selecting display data to capture 22, the user initiates the capture sequence. For example, the user may press a button so that the software 121 will capture the selected display data. Once the capture has been performed, the software 121 will convert the display data into the data object model 23 and save it in a file. In some embodiments, the file has a binary format that saves the object data model 23.

Exemplary tools for implementing the software 121 include technology such as “Rational Functional Tester” available from International Business Machines Corporation of Armonk, N.Y. In general, such technology involves advanced, automated functional and regression testing tools for testing of various applications, such as those written in Java, VisualStudio.NET, as well as web-based applications.

In this way, or by other similar technologies, it is possible to record user interface activities as a part of the capture process. Such tools may be used to capture some to all of the information available at the object level. For example, such tools may be used to communicate with or interrogate a running MFC or Java Application to learn about what controls it is using. Accordingly, the software 121 may learn about the various properties of the user interface components, such as, without limitation, size, color and contents and as well data that may be associated with the user interface.

Note that in some embodiments, not all frame information may be loaded during capture until an event takes place. Exemplary events include someone clicking in the frame (this behaviour maybe application specific). For example, until the user clicks on a tab, the data associated with the tab may not be loaded. In these embodiments, it is advisable to have users click on all the tabs or other such features in the display data to ensure loading of interactive components before initiating the capture.

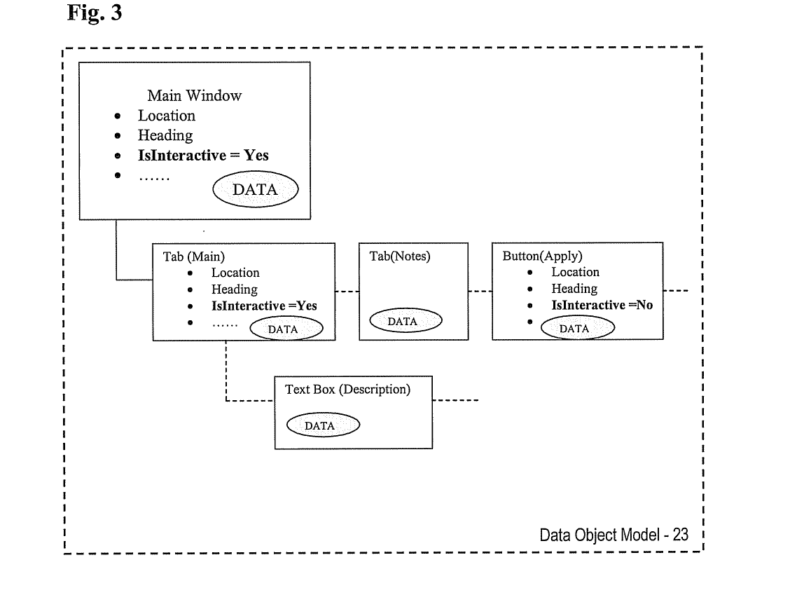

The object data model 23 may include user interface components created by the Capturing Tool 21. For example, in the above snapshot, a main window may be captured in a object data model 23, such as the one depicted in FIG. 3.

Depicted in FIG. 3 are exemplary components of the data object model 23. In this example, the data object model 23 includes a structure for each user interface component (such as a tab, a button, and a text box). Each component is depicted as a box, and may include children. More specifically, and as an example, the Main Window has children of Tab(Main), Tab(Notes) and Button(Apply). User interface (UI) components may include information regarding various properties such as:
Location (possible values ----> x,y coordinates with respect to parent);
Heading;
Color;
Data (possible values ---> Text Data/Graphic images);
IsInteractive (a flag, having possible values ---> Yes/No);
Type (possible values--> Tab/Text Box/Drop Down . . . etc);
InteractiveRegions (possible values ---> this is a structure dependent on the Type of the component, it captures the regions that are interactive);
and others.

The above list is not exhaustive and merely exemplary. However, it is expected that these properties will provide adequate information for recreating a visually similar user interface component. Data displayed in the various fields will correlate to the data displayed in the original display.

Note a variety of fields may be included. For example, the field called “IsInteractive” may be used to indicate to the software 121 whether one can interact with this UI component. The field “Description” may be an interactive component because users will be allowed to scroll down that UI component. While capturing screenshots, the software 121 will generally be equipped to determine whether a component is interactive or not. For example a drop down list will be interactive since if someone clicks on the drop down it will show a set of data.

The field called “Interactive Regions” is a structure that is valid only if “IsInteractive” is Yes. Interactive Regions includes information as to which regions are clickable. For example, this field includes the (x, y, xₙ, yₙ) values associated with the interactive area of the display. This structure will vary according to the type of the component. For example, if the interactive area is a “Tab” or a “Drop Down”, there may be just one region to click. However, if the interactive region is a text box, there may be four Regions. Namely, the regions may include ScrollUp, ScrollDown, ScrollRight, ScrollLeft. In various embodiments, the data object model 23 is serialized and saved in a binary file which is referred to as the Intelligent Image File 24.

The rendering tool 25 is provided as a part of the software 121. The rendering tool 25 provides capabilities for the user to display the intelligent image file 24. One skilled in the art will note that since the software 121 does not capture images at the pixel level, recreated images may not look exactly like original images on the display 136. The rendering tool 25 also helps the user to interact with recreated screenshots. This may be done in a variety of ways. In some embodiments, the rendering tool 25 does this by first checking if any of the sub-components are interactive (e.g., by checking the IsInteractive Flag). If the component is interactive, then the rendering tool 25 checks the Type of the sub-component and the “InteractiveRegions” values. For example, if someone clicks on the single InteractiveRegion, if the component is a Tab, then the rendering tool 25 will refresh the Tab with all the sub UI components and redraw the Tab (this way the user can switch between Tabs).

In some cases, such as those involving text scrolling, the rendering tool 25 also keeps track of how much of the text it has to display, depending on the user's interaction with the scroll bars. Accordingly, the rendering tool 25 is generally robust enough to take care of most the types of UI components.

Aspects of the software 121 may be implemented separately. For example, the capturing tool 21 may be implemented separately from the rendering tool 25. Accordingly, the software includes at least one of the capturing tool 21 and the rendering tool 25.

The capabilities of the present invention are generally implemented in software, firmware, hardware or some combination thereof. As one example, one or more aspects of the present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately.

Additionally, at least one program storage device readable by a machine, tangibly embodying at least one program of instructions executable by the machine to perform the capabilities of the present invention can be provided.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

What is claimed is:

1. A computer program product stored on machine readable media and comprising machine executable instructions for capturing data displayed upon a screen and providing interactive screenshots created therefrom, the product comprising instructions for:
receiving a selection of display data for capturing;
capturing the display data by identifying a user interface component in the display data and at least one property of each user interface component;
saving the captured display data as a data object model;
storing the data object model as an intelligent image file; and
using a rendering tool, reading the intelligent image file to provide the interactive screenshots.

2. The computer program product as in claim 1, wherein the user interface components comprise at least one of a location, a heading, a color, data, a flag, a type and a region.

3. The computer program product as in claim 1, wherein identifying user interface components comprises using an automated functional and regression testing tool.

4. The computer program product as in claim 1, wherein the product is provided as an add-in to one of an operating system and an application.

5. A computer program product stored on machine readable media and comprising machine executable instructions supplementing at least one of an application and an operating system with instructions for capturing data displayed upon a screen and providing interactive screenshots created therefrom, the product comprising instructions for:
receiving a selection of display data for capturing;
capturing the display data by using an automated functional and regression testing tool to identify at least one user interface component comprising at least one of a location, a heading, a color, data, a flag, a type and a region in the display data, and at least one property of each user interface component;
saving the captured display data as a data object model;
storing the data object model as an intelligent image file; and
using a rendering tool, reading the intelligent image file to provide the interactive screenshots.
